(19) United States
(12) Patent Application Publication
(10) Pub. No.: US 2005/0050298 A1
(43) Pub. Date: Mar. 3, 2005

(54) Method and system for mapping open grid services architecture service data to native resource representation

(75) Inventor: Joshy Joseph, Poughkeepsie, NY (US)

Correspondence Address: Cantor Colburn LLP, 55 Griffin Road South, Bloomfield, CT, 06002, US

(73) Assignee: INTERNATIONAL BUSINESS MACHINES CORPORATION, ARMONK, NY (US)

(21) Appl. No.: 10/648,638

(22) Filed: Aug. 25, 2003

(51) Int. Cl. G06F 15/00

(52) U.S. Cl. 712/1

(57) ABSTRACT

A method for mapping Open Grid Services Architecture (OSGA) service data to a native resource representation thereof includes defining a set of standard mapping rules for service data descriptions in a service-oriented architecture, wherein the set of standard mapping rules are implemented through an OSGA Service Data Mapping Language (OSDML) configured to support complex mapping through extensible language features.

### BACKGROUND

The present invention relates generally to computer architecture systems and, more particularly, to a method and system for mapping Open Grid Services Architecture (OSGA) service data to its native resource representation.

Grid computing enables the virtualization of distributed computing and data resources such as processing, network bandwidth and storage capacity to create a single system image, granting users and applications seamless access to vast IT capabilities. Just as an Internet user views a unified instance of content via the Web, a grid user essentially sees a single, large virtual computer. At its core, grid computing is based on an open set of standards and protocols referred to as an Open Grid Services Architecture (OGSA). The OGSA enables communication across heterogeneous, geographically dispersed environments. With grid computing, organizations can optimize computing and data resources, pool them for large capacity workloads, and share them across networks for enabling collaboration.

A basic premise of OSGA is that everything is represented by a service (i.e., a network enabled entity that provides some capability through the exchange of messages. Computational resources, storage resources, networks, programs and databases are all examples of such services. More specifically, OSGA represents everything as a Grid service (i.e., a Web service that conforms to a set of conventions and supports standard interfaces for such purposes as lifetime management). This core set of consistent interfaces, from which all Grid services are implemented, facilitates the construction of higher order services that can be treated in a uniform way across layers of abstraction.

The OGSA specification defines ‘service data description’ as a mechanism by which a stateful service in a service-oriented architecture can expose its state data. These service data descriptions are declared as part of the public service interface. There are cases where these services may hold its ‘true state’ external to the service implementation. Some examples of these cases include services that hold states in databases and/or CIM (common information model)/SNMP (simple network management protocol) resource instrumentation.

In these kinds of service implementation, a service's service data is the state in the native resource implementation, and the services act as delegates for the resource endpoints. However, there is an inherent architectural and design problem with these kinds of delegation services, wherein the service developer needs to design code for mapping from a service's service data description to the ‘true’ native resources representation and its access mechanisms. Normally, this results in the involvement of domain experts with the design and coding of each service. This process may be simple or complex, depending on the type of the resource to be mapped, the complexity of the service data description, and the probability of the frequency by which this mapping changes. Therefore, it is desirable to be able to reduce the problem of this programmatic complex and inflexible mapping exercise to a more elegant design time modeling exercise with the help of a domain expert.

### SUMMARY

The foregoing discussed drawbacks and deficiencies of the prior art are overcome or alleviated by a method for mapping Open Grid Services Architecture (OSGA) service data to a native resource representation thereof. In an exemplary embodiment, the method includes defining a set of standard mapping rules for service data descriptions in a service-oriented architecture, wherein the set of standard mapping rules are implemented through an OSGA Service Data Mapping Language (OSDML) configured to support complex mapping through extensible language features.

In another aspect, a system for mapping Open Grid Services Architecture (OSGA) service data to a native resource representation thereof includes a defined set of standard mapping rules for service data descriptions in a service-oriented architecture, wherein the set of standard mapping rules are implemented through an OSGA Service Data Mapping Language (OSDML) configured to support complex mapping through extensible language features.

### BRIEF DESCRIPTION OF THE DRAWINGS

Referring to the exemplary drawings wherein like elements are numbered alike in the several Figures:

FIG. 1 is a schematic block diagram illustrating the mapping of service data of an OSGA service to a native resource representation such as a common information model (CIM) resource, database table and/or table column, in accordance with an embodiment of the invention;

FIG. 2 is a schematic block diagram illustrating the use of an OGSA service data mapping language (OSDML) to define a common set of mapping rules and definitions, in accordance with a further aspect of the invention;

FIG. 3 is schematic block diagram of the mapping of service data as shown in FIG. 1, further illustrating a service data mapping engine that uses the OSDML depicted in FIG. 2, in accordance with a further aspect of the invention;

FIG. 4 is a schematic block diagram of exemplary features of the mapping engine depicted in FIG. 3; and

FIG. 5 is a schematic block diagram illustrating the operation of the service data mapping engine in further detail.

### DETAILED DESCRIPTION

Disclosed herein is a method and system to map service data description of the Open Grid Service Architecture (OGSA) to its native resource representation. Briefly stated, a common set of mapping rules and definitions is defined so as to help reduce complex programmatic mapping of service data descriptions to native resource representations, to a more design time exercise. In particular, an embodiment of the present invention describes a XML language referred to hereinafter as an OGSA Service Data mapping Language (OSDML) that includes features to support any data/resource sources and to support complex mapping through extensible language features. Some of the features of OSDML include, but are not limited to:
defining the mapping of a service data descriptions to its native resource representation at any levels of data definition granularity;
defining an extensible set of data source and/or resource access mechanisms;
defining parameterization capabilities to support dynamic values such as instance identifiers, keys, etc.;
defining executable scripts (e.g., XSL, SQL) to process the data (transformation and queries);
defining language extensibility to support advanced features like new query languages, new resources and complex mapping logic (e.g, JOINS, object hierarchies and relationships, etc.);
defining a mechanism to define private mapping for a service's internal state; and
defining a set of rules for defining and mapping service data change notification subscriptions from its native resource implementation.

In addition, there is also disclosed a flexible framework engine to process the rules and mappings defined by the OSDML language. This framework works with the mapping language and can support pluggable native data adapters based on a set of well-defined interfaces. Some of the features supported by the framework engine include, but are not limited to:
defining a uniform interface to services implementation;
a pluggable provider interface to support language extensions and new service data providers;
basic infrastructure to support language features like parameterization, flexible data source binding and pluggable script execution engines, etc.; and
a document repository and a generic interface to support OSDML instance data retrieval.

As will be appreciated from the following description, one advantage of the service data mapping language and associated framework engine is the separation of a “service developer role” from “service domain expert/deployer role.” For example, in a CRM (common resource model) service implementation, a CIM (common information model) expert can define the mapping (through OSDML) of Service Data to native resource properties (CIM properties), supporting methods (get/set/invoke) and query language (WQL), while a service developer only worries about implementing CRM service based on the CRM specification. Also, there is the ability to create service data mapping for a service with heterogeneous data sources or resource instrumentation at different levels of service data type's element hierarchy. In this manner, certain rules may be enforced, such as some portion of the service data values coming from databases, while some others are coming from CIMOM (common information object manager) or from another data source. Furthermore, this external rule/configuration definition enables the domain experts and service deployers to change the mapping rules with out changing its service implementations, while the flexible mapping engine provides a set of standard interfaces and a pluggable resource-mapping framework to support language extensibility.

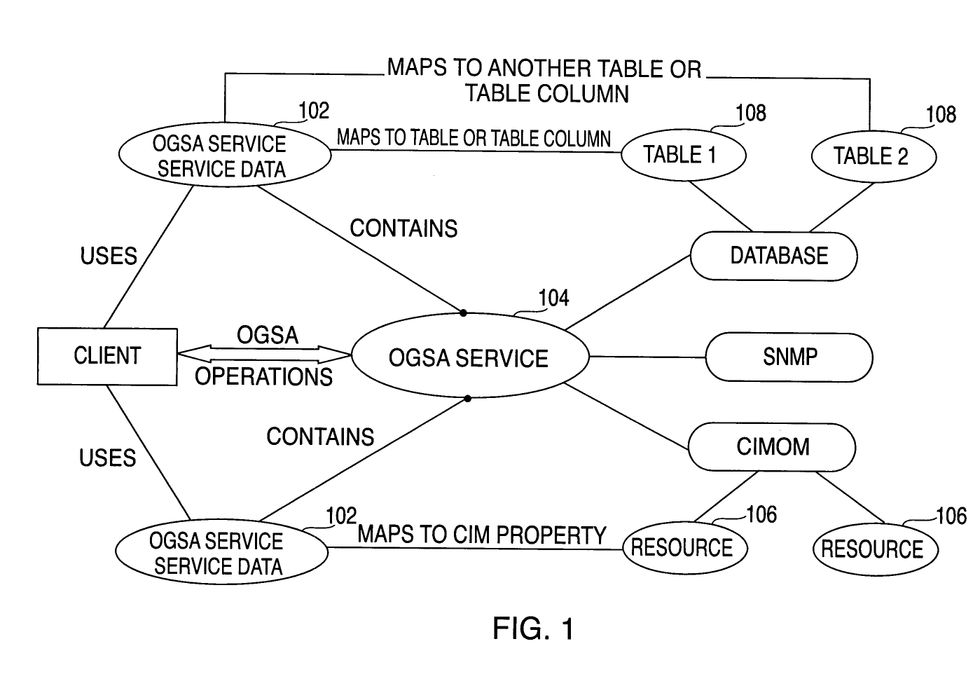

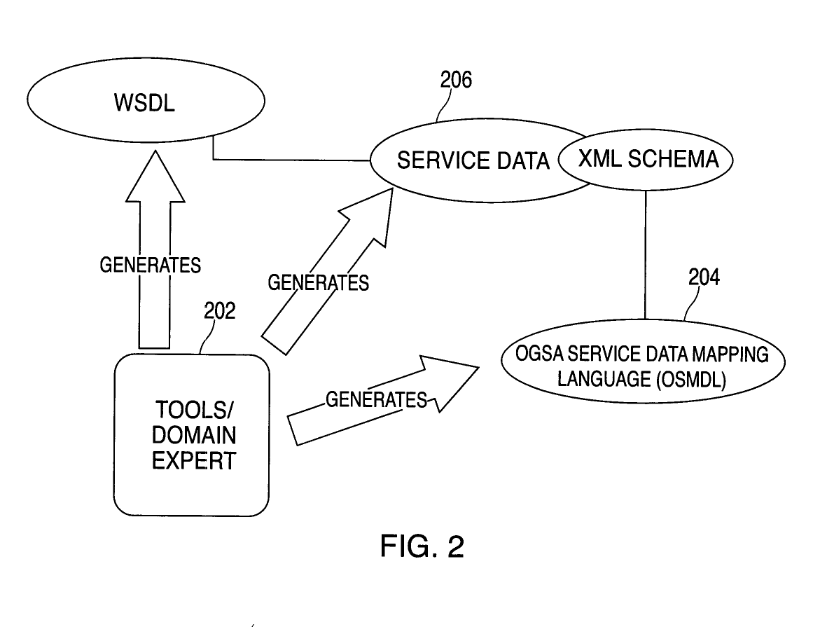

Referring initially to FIG. 1, there is shown a schematic diagram 100 of a model for mapping of service data 102 of an OSGA service 104 to a native resource representation such as a common information model (CIM) resource 106, database table 108 and/or table column, in accordance with an embodiment of the invention. FIG. 2 is a schematic block diagram 200 illustrating the use of an OGSA service data mapping language (OSDML) to define a common set of mapping rules and definitions, in accordance with a further aspect of the invention. As is shown, the model assists a Domain expert(s) 202 to come up with a set of standard mapping rules 204 (i.e., the OSDML) to support any data/resource sources, which represents the OGSA Service Data Definitions 206. Moreover, the model works in conjunction with the Service Data Description and uniquely identifies each service data descriptions mapping rules using the XML ‘QName’ of the Service Data Description. The complexity of the mapping depends on the underlying resource representation and the requirements for the service data descriptions. This mapping is simple in most of the service data descriptions. For example, in the case of CRM to CIM mapping, the complexity is minimum as we map each CRM service data to its corresponding CIM property as defined in the CIM MOF.

However, in the case of relational databases, the mapping may be very complex, as a result of the presence of multiple tables, normalized queries and relationships. Thus, the language is flexibly defined so as to accommodate any requirements on the mapping, provided that the engine can support the real processing. Accordingly, these extensibility and complexity requirements in the language may be accommodated through custom scripts (SQL and XSL), rules and parameterization techniques (i.e., the ability to pass runtime values). Also, other rule engines and rule languages based on the resource requirements need to be supported.

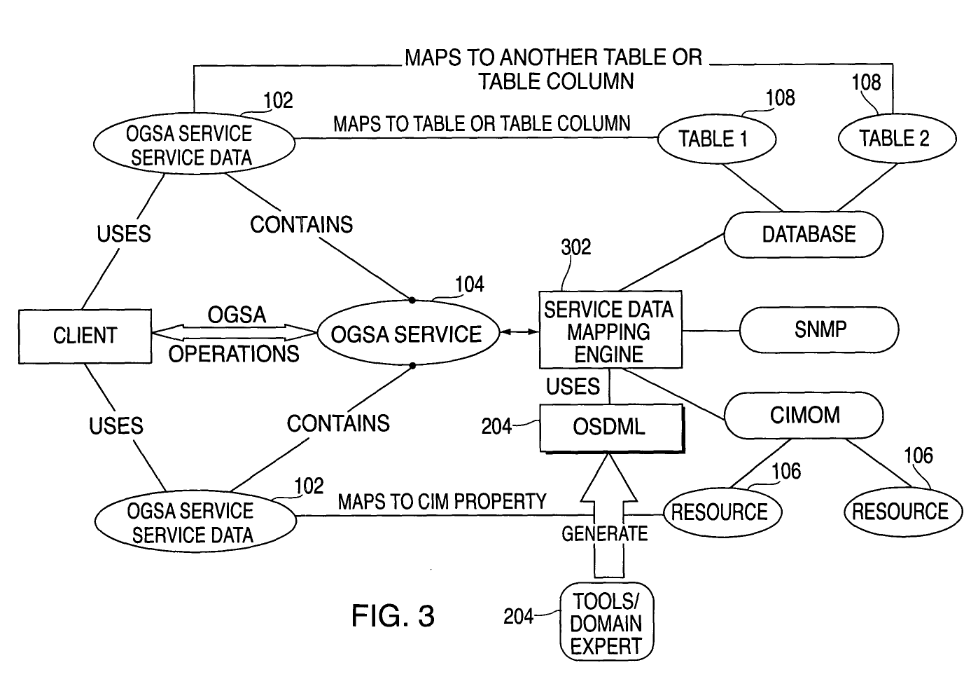

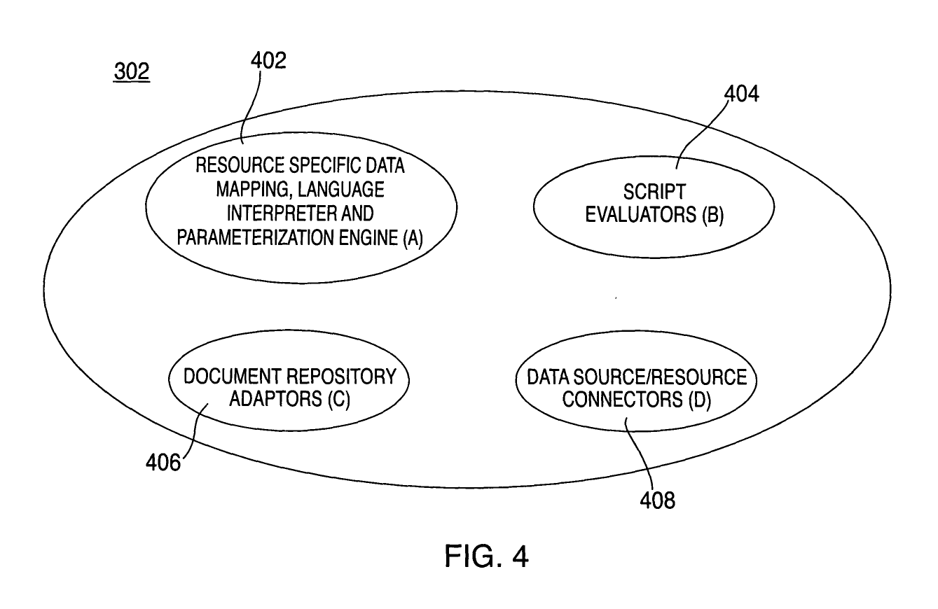

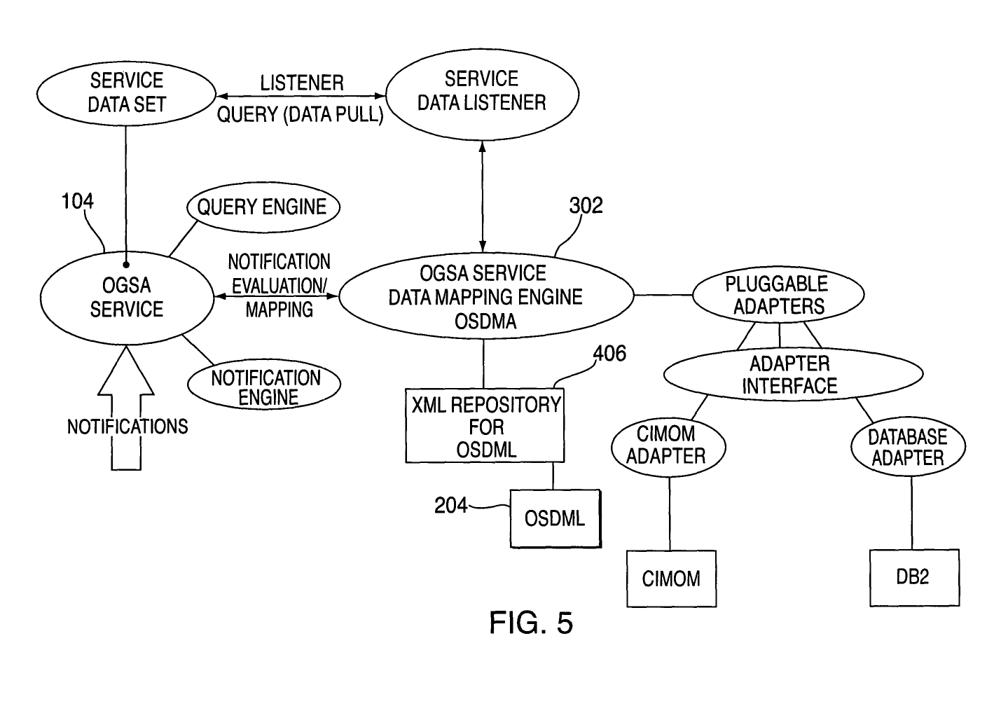

In addition to the basic service data definition mapping, the mapping language also provides polices for defining the data source information and supported actions on the data source. An instance XML document of OSDML is created by the previous mapping exercise, which may be used by any OGSA Service Data Mapping engine (OSDME) 302, as shown in FIG. 3. The implementation of the OSDME 302 is configured to support basic OSDML language features. This language supports extension capabilities to in turn support more complex mapping and script executions. The support for language extensions are considered value added features of the engine. FIGS. 4 and 5 illustrate the ODSML engine details, which include a set of pluggable adapters 502 (FIG. 5) and connectors based on the resource or data source. This engine design is flexible to accommodate language requirements and extensions for any specific data sources.

As is shown more particularly in FIG. 4, the core components of the service data mapping engine 302 include a Resource specific Data Mapping language interpreter and parameterization engine 402 (A), Script evaluators 404 (B), Document Repository Adaptors 406 (C) and Data source/resource connectors 408 (D).

Resource Specific Data Mapping Language Interpreter and Parameterization Engine (A)

This engine is responsible for the mapping from service data descriptions to native resource properties. It can also can supply the runtime parameters needed for the resource provider to uniquely identify the resource. In addition, this is a pluggable framework to support any data source/resource mapping, while providing a set of standard interfaces for interoperability. This engine also works with other adaptors and script evaluators to retrieve the data from the underlying resource and transform it to a format required by the service.

Script Evaluators (B)

The script evaluators are used to transform the existing data format to some other format as specified by the domain expert. Some of the possible script engines include, for example, SQL engines and XSL/XQuery engines.

Document Repository Adaptors (C)

These repositories hold the instance mapping XML data in its own native store or in some other repositories (e.g., database). This provides a standard interface(s) for data access.

Data Source/resource Connectors (D)

These are native data source connectors and are responsible for managing the connection to the resource provider. The framework at runtime provides most of the data source properties.

Thus, as outlined above, the present invention embodiments include the OGSA Service Data Mapping Language (OSDML) definition, its extensibility features and the modeling process, in conjunction with OGSA service data definitions and other supporting resource representations (MOF, Database Schema etc), as well as the processing engine as described earlier. Although the language is defined through XML Schema, this is by way of example only, and it will be appreciated by those skilled in the art that this language may also be defined through other language definitions and/or rules for ease of use.

Presented below are a pair of exemplary mapping scenarios addressed by the present invention embodiments:

Service Data Definitions to Relational Database Schema

This is a complex mapping case wherein the service data definition may be created by joining multiple tables and applying different relations. Initially, the Database designer creates a custom SQL that can retrieve all the necessary information from the database using service data description and the data base schema. The custom SQL allows the plug points for parameters at runtime. Additionally, the designer defines the mapping of the results of the SQL to individual service data description elements or defines some custom style sheets (XSL) for data transformation from database known format (XML data or result sets) to the service data description. The engine is thereafter responsible for applying the SQL and implementing the transformation.

Service Data Definitions to CIM MOF

The mapping of service data definitions to CIM MOF is mostly a one-to-one mapping of service data definition to a CIM property.

Sample Mapping #1:

1. MOF

A CIM MOF file describing the Operating System Class is shown below. It will be noted that most of the contents are omitted for purposes of clarity and readability.

class CIN_ComputerSystem : CIM_System {

[MaxLen (256), ArrayType (“Indexed”), Description (
“OtherIdentifyingInfo captures additional data, beyond”
“System Name information, that could be used to identify”
“a ComputerSystem. One example would be to hold the”
“Fibre Channel World-Wide Name (WWN) of a node. Note that”
“if only the Fibre Channel name is available and is”
“unique (able to be used as the System key), then this”
“property would be NULL and the WWN would become the”
“System key, its data placed in the Name property.”),
ModelCorrespondence {
“CIM_ComputerSystem.OtherIdentifyingInfo” } ]
string OtherIdentifyingInfo [ ];
<<< The rest of the MOF file is omitted for clarity >>>

}

2. Sample Service Data Representation

Here, a CRM WSDL portType called ComputerSystem is defined, with OtherIdentifyingInfo as one of the service data descriptions.

```
<portType name= “ComputerSystem” extends= “system: System” >
    <operation name= “SetPowerState”>
    <input message= “compsys:SetPowerStateRequest”/>
    <output message= “compsys:SetPowerStateResponse”/>
    </operation>
    <gsdl : serviceData name= “OtherIdentifyingInfo”
        type= “OtherIdentifyingInfoType”
        minOccurs= “ 0 ” maxOccurs= “unbounded”
        mutability= “mutable”>
    </gsdl : serviceData>
</portType>
<xsd: complexType name= “OtherIdentifyingInfoType”>
    <xsd: simpleContent>
        <xsd: extension base= “compsys : StringofLength256”>
            <xsd: attribute name=“ index”
            type= “xsd: nonNegativeInteger”
            use= “ required”/>
        </xsd: extension>
    </xsd: simpleContent>
</xsd: complexType>
<xsd:simpleType name= “StringofLength256”>
    <xsd:restriction base= “xsd:string”>
        <xsd:maxLength value=“256”/>
    </xsd: restriction>
</xsd: simpleType>
```

3. Sample Mapping OSDML XML

```
<ServiceDataName name= “ComputerSystem/OtherIdentifyingInfo”>
<baseRefdoc> http://ibm.com/ogsa/schema/crm/ComputerSystem.wsdl
</baseRefdoc>
<sdReference name= “.” >
  <sdDataType>StringArray< /sdDataType>
  <cim-Mapping>
    <cim-property-map>
      <cim-property-name name= “OtherIdentifyingInfo” />
      <cim-class name= “CIM_ComputerSystem”/>
      <cim-property name= “ArrayType”
          value= “indexed” />
      <cim-property name= “MaxLen” value= “256”>
      <cim-method name= “get”>
        <cim-queryString> </cim-queryString>
      </cim-method>
    </cim-property-map>
  </ cimMapping>
  <datasource>
    <cim- instance>@instance<cim- instnace>
    <cim-property name= “ArrayType” type= “key” value=
    “@keyBinding” />
    <ref>dataSourceref1</ref>
  </datasource>
</sdReference>
</ServiceDataName >
<datasources name= “dataSourceref1” >
    <cimom>
      <serverName>cimom< /serverName>
      <serverPort>1234< /serverPort>
    </cimom>
</datasources>
```

Sample Mapping #2:

Data base mapping

```
<ServiceDataName name= “ComputerSystem/OtherIdentifyingInfo”>
<baseRefdoc> http://ibm.com/ogsa/schema/crm/ComputerSystem.wsdl
</baseRefdoc>
<sdReference name= “.” >
    <sdDataType>StringArray</sdDataType>
    <db-Mapping>
        <db-property-name name= “resource-name” value= “ ”
                type= “ ” />
        <db-property-name name= “column-name” value= “ ”
                type= “ ” />
        <db-property-name name= “SQL” value= “ ”
                type= “ ” />
        <db-property-name name= “db-script” value= “ ”
                type= “ ” />
    </db-Mapping>
    <datasource>
        <db-property name= “tableName” value= “@tableName”
            type= “string”>
        <ref>dataSourceref2</ref>
    </datasource>
</sdReference >
</ServiceDataName >
<datasources name= “dataSourceref2” >
    <db>
        <db-property name= “serverName” value = “db2:myHost”
            type= “string”>
        <db-property name= “serverPort” value = “1234”
            type= “string”>
    </db>
</datasources>
```

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for mapping Open Grid Services Architecture (OSGA) service data to a native resource representation thereof, the method comprising:
defining a set of standard mapping rules for service data descriptions in a service-oriented architecture;
wherein said set of standard mapping rules are implemented through an OSGA Service Data Mapping Language (OSDML) configured to support complex mapping through extensible language features.

2. The method of claim 1, wherein said OSDML is an extensible markup language (XML).

3. The method of claim 1, wherein said OSDML defines an extensible set of at least one of: data source mechanisms and resource access mechanisms.

4. The method of claim 1, wherein said OSDML defines parameterization capabilities for supporting dynamic values.

5. The method of claim 1, wherein said OSDML defines executable scripts to process data transformation and queries.

6. The method of claim 1, wherein said OSDML defines a mechanism for defining private mapping for an internal state of a service.

7. The method of claim 1, wherein said OSDML defines a set of rules for defining and mapping service data change notification subscriptions from a corresponding native resource implementation thereof.

8. The method of claim 1, further comprising:
defining a flexible framework engine for processing rules and mappings defined by said OSMDL.

9. The method of claim 8, wherein said framework engine includes a uniform interface to services implementation.

10. The method of claim 8, wherein said framework engine includes a pluggable provider interface, said pluggable provider interface being configured to support language extensions and new service data providers.

11. The method of claim 10, wherein said framework engine is configured to support at least one of: parameterization, flexible data source binding and pluggable script execution.

12. The method of claim 10, wherein said framework engine further comprises a document repository.

13. The method of claim 10, wherein said framework engine further comprises a generic interface for supporting OSDML instance data retrieval.

14. The method of claim 10, wherein said pluggable provider interface comprises at least one of: a common information object manager (CIMOM) and a database adapter.

15. The method of claim 10, wherein said engine is configured to map service data definitions to relational database schema.

16. A system for mapping Open Grid Services Architecture (OSGA) service data to a native resource representation thereof, comprising:
a defined set of standard mapping rules for service data descriptions in a service-oriented architecture;
wherein said set of standard mapping rules are implemented through an OSGA Service Data Mapping Language (OSDML) configured to support complex mapping through extensible language features.

17. The system of claim 16, wherein said OSDML is an extensible markup language (XML).

18. The system of claim 16, wherein said OSDML defines an extensible set of at least one of: data source mechanisms and resource access mechanisms.

19. The system of claim 16, wherein said OSDML defines parameterization capabilities for supporting dynamic values.

20. The system of claim 16, wherein said OSDML defines executable scripts to process data transformation and queries.

21. The system of claim 16, wherein said OSDML defines a mechanism for defining private mapping for an internal state of a service.

22. The system of claim 16, wherein said OSDML defines a set of rules for defining and mapping service data change notification subscriptions from a corresponding native resource implementation thereof.

23. The system of claim 16, further comprising a flexible framework engine for processing rules and mappings defined by said OSMDL.

24. The system of claim 23, wherein said framework engine includes a uniform interface to services implementation.

25. The system of claim 23, wherein said framework engine includes a pluggable provider interface, said pluggable provider interface being configured to support language extensions and new service data providers.

26. The system of claim 25, wherein said framework engine is configured to support at least one of: parameterization, flexible data source binding and pluggable script execution.

27. The system of claim 25, wherein said framework engine further comprises a document repository.

28. The system of claim 25, wherein said framework engine further comprises a generic interface for supporting OSDML instance data retrieval.

29. The system of claim 25, wherein said pluggable provider interface comprises at least one of: a common information object manager (CIMOM) and a database adapter.

30. The system of claim 25, wherein said engine is configured to map service data definitions to relational database schema.
